(19) United States
(12) Patent Application Publication
(10) Pub. No.: US 2025/0075131 A1
(43) Pub. Date: Mar. 6, 2025

(54) Continuous Feed Processor

(71) Applicant: Bright Sand Industries, Inc., Detroit, MI (US)

(72) Inventor: Earl R DECKER, Windsor (CA)

(21) Appl. No.: 18/820,172

(22) Filed: Aug. 29, 2024

Related U.S. Application Data
(60) Provisional application No. 63/579,510, filed on Aug. 29, 2023.

(51) Int. Cl. C10B 47/30; B09B 3/35; B09B 3/40; C10B 53/00

(52) U.S. Cl. CPC C10B 47/30; B09B 3/35; B09B 3/40; C10B 53/00

(57) ABSTRACT

A device directed to a continuous feed processor of waste material having a receiving chamber with first and second openings with the first opening accepting waste material, a rotary heating chamber having starting and finishing openings with the starting opening connected to the second opening of the receiving chamber, and a heat source for heating the rotary heating chamber is presented. Also presented is a material removal opening connected to the finishing opening of the rotary heating chamber, and a post-heating chamber connected to the finishing opening of the rotary heating chamber. The post-heating chamber comprising one or more processing modules selected from a hydrocracking module, a nanoparticle deposition module, and a catalyst-based gas conversion module.

### RELATED APPLICATIONS

The present application claims benefit from earlier filed U.S. Provisional Application No. 63/579,510, filed Aug. 29, 2023, which is incorporated by reference in its entirety for all purposes.

### BACKGROUND

### Field of Invention

The present disclosure relates to a continuous feed processor and method to continuously process waste material and produce, among other things, synthetic gas for energy generation, or other uses.

There are numerous industrial processes that require reliable steady sources of high temperature air, for example, gasification, pyrolysis, and related furnaces, kilns, and heaters. Manufacturing processes that involve glass, metal, and ceramic materials are just a few instances of processes that consume large amounts of energy resources to produce the high temperature conditions needed to manipulate these materials. Concurrently there is an abundance of municipal solid waste (“MSW”) that needs to be processed in the most energy efficient manner while also breaking down any pollutants or biohazards present in the waste.

Equipment and processes to combine the decomposition of solid waste with the production of energy and other products are of great interest to both producers and consumers of energy and waste materials.

### SUMMARY OF THE DISCLOSURE

The present disclosure is directed to a device including a continuous feed processor of waste material having a receiving chamber with first and second openings with the first opening accepting waste material, a rotary heating chamber having starting and finishing openings with the starting opening connected to the second opening of the receiving chamber, and a heat source for heating the rotary heating chamber is presented. Also presented is a material removal opening connected to the finishing opening of the rotary heating chamber, and a post-heating chamber connected to the finishing opening of the rotary heating chamber. The post-heating chamber comprising one or more processing modules selected from a hydrocracking module, a nanoparticle deposition module, and a catalyst-based gas conversion module.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a plan view of one embodiment of the present disclosure;

FIG. 2 is a plan view of one embodiment of the present disclosure

FIG. 3 is a plan view of one embodiment of the present disclosure;

FIG. 4 is a plan view of one embodiment of the present disclosure;

FIG. 5 is a plan view of one embodiment of the present disclosure;

FIG. 6 is a plan view of one embodiment of the present disclosure;

FIG. 7 is a plan view of one embodiment of the present disclosure;

FIG. 8 is a plan view of one embodiment of the present disclosure, and

FIG. 9 is a plan view of one embodiment of the present disclosure.

### DETAILED DESCRIPTION

The present application is directed to a continuous feed processor of waste material comprising a receiving chamber having first and second openings with the first opening accepting waste material, a rotary heating chamber having starting and finishing openings with the starting opening connected to the second opening of the receiving chamber, a heat source for heating the rotary heating chamber, a material removal opening connected to the finishing opening of the rotary heating chamber, a post-heating chamber connected to the finishing opening of the rotary heating chamber, the post-heating chamber comprising one or more processing modules, and the one or more processing modules comprising one or more of a hydrocracking module, a nanoparticle deposition module, and a catalyst-based gas conversion module.

The presently disclosed processor can handle waste material that is baled or loose. The waste material can be introduced into the receiving chamber which can have a rotary screw to move the waste material into the rotary heating chamber. The type of moving device can be selected based on the properties of the waste material being processed.

According to various embodiments of the present disclosure, the heat source system supplies heat to the rotary heating chamber without exposing the waste material to direct fire from the heat source. The heat source can provide heat directly to the exterior of the rotary heating chamber and thereby increase the temperature in the interior of the rotary heating chamber to temperatures ranging from 250 to 1000 C. The selected interior temperature will vary with the characteristics of the waste material being processed.

The presently disclosed rotary heating chamber can include at least one internal fin in order to move the waste material through the chamber. There can also be more fins which can be offset from one another.

The presently disclosed processing modules can be located downstream in the device after the processing of the waste material has substantially occurred, and can be chosen depending on the characteristics of the waste material and the gaseous products produced by the processing. The device allows for the replacement of the processing modules as needed. Some of the possible modules include, for example, hydrocracking module, a nanoparticle deposition module, and a catalyst-based gas conversion module.

According to additional embodiments of the present disclosure, provided is a device for the continuous processing of waste material having a first chamber having an opening sized to accept bales of waste material, the first chamber connected to a cutter section, the cutter section having interior walls and an outlet, and comprising cutting blades attached to its interior walls. Also present is a first bale mover to move bales into the first chamber, a second bale mover to move bales from the first chamber into the cutter section, a chute connected to the outlet of the cutter section, and a first door located between the cutter section and the chute. A cylindrical rotary calciner having opposing first and second ends, connected at its first end to the chute, and having at least one internal fin is heated by a heat source to a processing temperature. A conversion chamber is connected to the second end of the cylindrical rotary calciner, and has an opening leading to a material removal chute with a second door located between the conversion chamber and the material removal chute. Also fluidly connected to the conversion chamber is a catalyst chamber which in turn has a gas outlet fluidly connected to it.

The presently disclosed device further comprises a conveyor to move bales of waste material into position for the first bale mover to move a bale into the first chamber. The bales are cut open with the cutting blades of the cutter section which can be adjustable blades.

The presently disclosed device further comprises a first rotary union connecting the chute to the first end of the cylindrical rotary calciner, and a second rotary union connecting the second end of the cylindrical rotary calciner to the conversion chamber.

The presently disclosed device further comprises drive gears located on the outer perimeter of the cylindrical rotary calciner, and in some cases, the cylindrical rotary calciner is surrounded by a heat containment vessel. The heat source provides heat to a space between the cylindrical rotary calciner and the surrounding heat containment vessel. The temperature in the cylindrical rotary calciner can vary between about 250 to 1000 C.

In the presently disclosed device, the chute further comprises at least one compressed air inlet positioned to move the contents of the cut opened bale through the chute.

In some embodiments, the presently disclosed device features hydraulically powered rams to move the bail contents.

In this presently disclosed device, both the cylindrical rotary calciner and the conversion chamber are each sized to hold the contents of one or more bales. Additionally, the material removal chute has one or more quench liquid inlets positioned on its interior walls.

At least one particle filter can be located between the catalyst chamber and the conversion chamber in some cases of the presently disclose device. The catalyst chamber can contain one or more of the components selected from the group consisting of carbon, catalyst, supported catalysts, and mixtures thereof.

This specification further discloses a method for the continuous processing of waste material. In some instances, the presently disclosed method can either process bales of waste material or loose waste material. Baled material features waste material that has been compressed and then, in the compressed state, wrapped with a suitable material to hold the compressed material in a relatively compressed state.

The presently disclosed process begins by placing a bale of waste material, or loose material, into the suitable embodiment of the present device. The bale is then moved into the first chamber with the first bale mover, and a second bale mover is used to move the bale of waste material from the first chamber into the cutter section (no cutter section is needed if the waste material is not baled), where the bale of waste material is cut open with the cutting blades to provide loose waste material and cut baling material.

The first door is then opened, and the loose waste material and cut baling material is moved into the chute, through the chute, and into the cylindrical rotary calciner where the loose waste material and cut baling material is heated to a processing temperature of 250 to 1000 C. The loose waste material and cut baling material is then processed by rotating the cylindrical rotary calciner to mix the loose waste material and cut baling material, and move the loose waste material and cut baling material from the first end to the second end of the cylindrical rotary calciner and into the conversion chamber.

In order to move the loose waste material and cut baling material through the chute and into the cylindrical rotary calciner in a timely manner compressed air can be added.

The processing of the loose waste material and cut baling material continues in the conversion chamber. The second door is opened and any unprocessed loose waste material and cut bailing material is moved into the material removal chute.

Any gases produced during the processing of the loose waste material and cut baling material are passed through the catalyst chamber into the gas outlet.

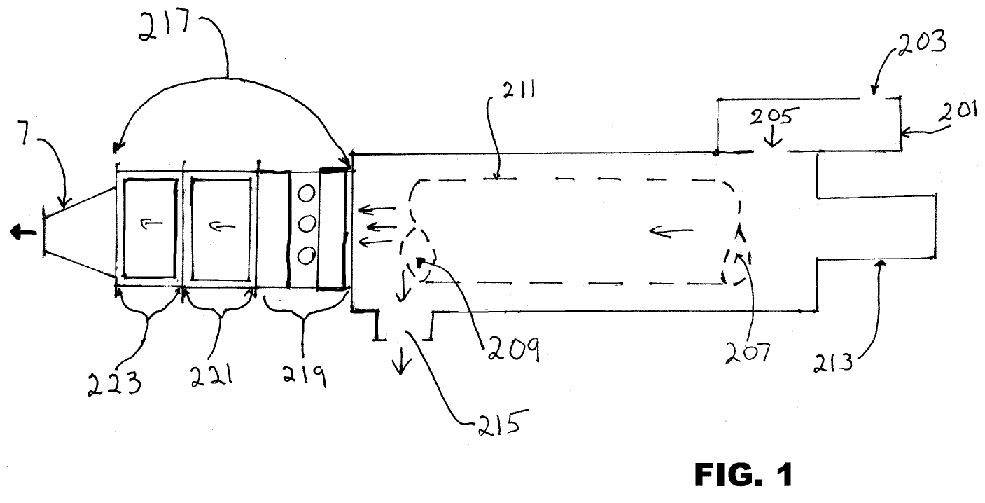

According to other embodiments of the present disclosure, and illustrated in detail in FIGS. 1-6, provided is a continuous feed processor of loose waste material comprising a receiving chamber 201 having first and second openings 203 and 205 with the first opening accepting loose waste material, and a conveying system to continuous move the loose waste material from the first opening 203 to the second opening 205. The rotary heating chamber 211 has starting and finishing openings (207, 209) with the starting opening 207 connected to the second opening 205 of the receiving chamber and is provided with a source for atmospheric air or compressed gases 213 for assisting in heating the rotary heating chamber, or for the movement of the waste material.

With respect to the loading system of the presently disclosed device, the loading system can be selected from various methods, such as, a rotary screw to drop materials into the processor, or pushing rams to push bales into the processor, or modified rams to push plastic waste of various sizes into the processor. In many cases, a sealing rotating door can be provided in order to isolate the high temperature processor from the loading system.

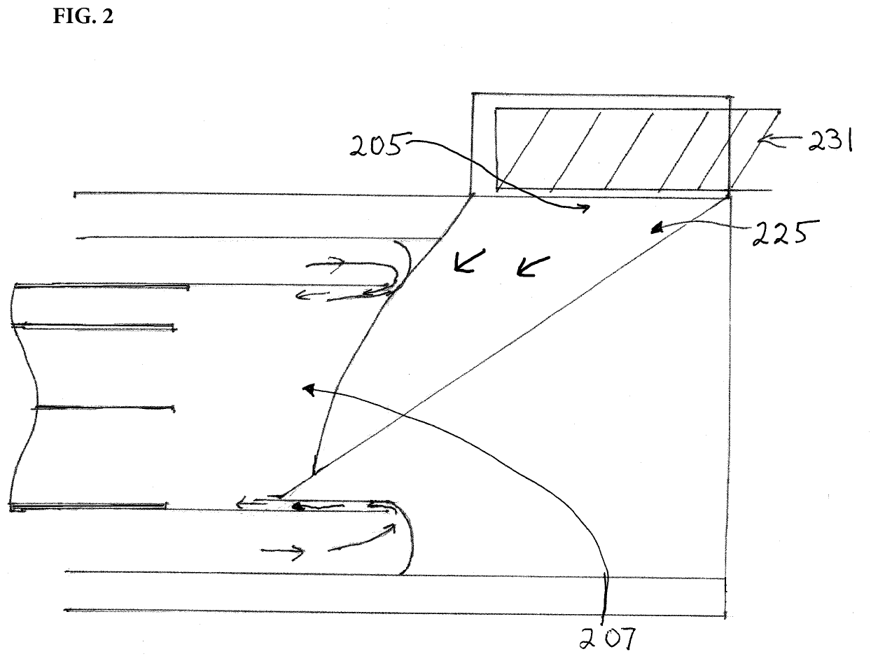

As seen in FIG. 2, one embodiment of the present system can utilize a rotary screw 231 as means to move waste material into the rotary heating chamber area. Additionally, the present system can also include a feed-in chute 225 leading from the second opening 205 of the receiving chamber to the rotary heating chamber opening 207.

The presently disclosed rotary heating chamber can have at least one internal fin (not shown) to assist in the movement of waste materials through the processor. In installations with two or more fins, the fins can be offset from one another. In some cases, the inner process tube or drum can be rotated in either direction. The drum rotation can vary from 360 degrees in either direction, to rotation in 190 degrees in one direction then 180 degrees in the opposite direction, or the rotation can be in any increment between 360 degrees.

The presently disclosed rotary heating chamber is located inside an insulated outer shell which can be provided with heated air from various locations along the length of the outer shell. Heated air can be introduced at the bottom along the horizontal length of the outer shell and then enter the space between the inner rotary heating chamber and the outer shell, or in other cases, heated air can be introduced at either end of the outer shell and flow to the other end, or any combination thereof. The outer shell provides insulation to retain heat, and also acts as a conduit to introduce heated air to the exterior of the inner rotating tube.

In other embodiments of the present disclosure, the rotary drum assembly is open at both ends, and is positioned with a slight decline toward the starting end of the process, that is, the right side of FIG. 1, with a decline ranging from 2% to 5% grade.

Also present is a material removal opening 215 connected to the finishing opening 209 of the rotary heating chamber, and through which material that cannot be processed is removed.

A post-heating chamber 217 is connected to the finishing opening of the rotary heating chamber and comprises one or more processing modules (219, 221, 223). The processing modules can include one or more of a hydrocracking module, a nanoparticle deposition module, and a catalyst-based gas conversion module.

The conveying system located between 203 and 205, and used in the presently disclosed processor can include, for example, a rotary screw, a conveyor belt, or a ram system to move the waste material into the rotary heating chamber.

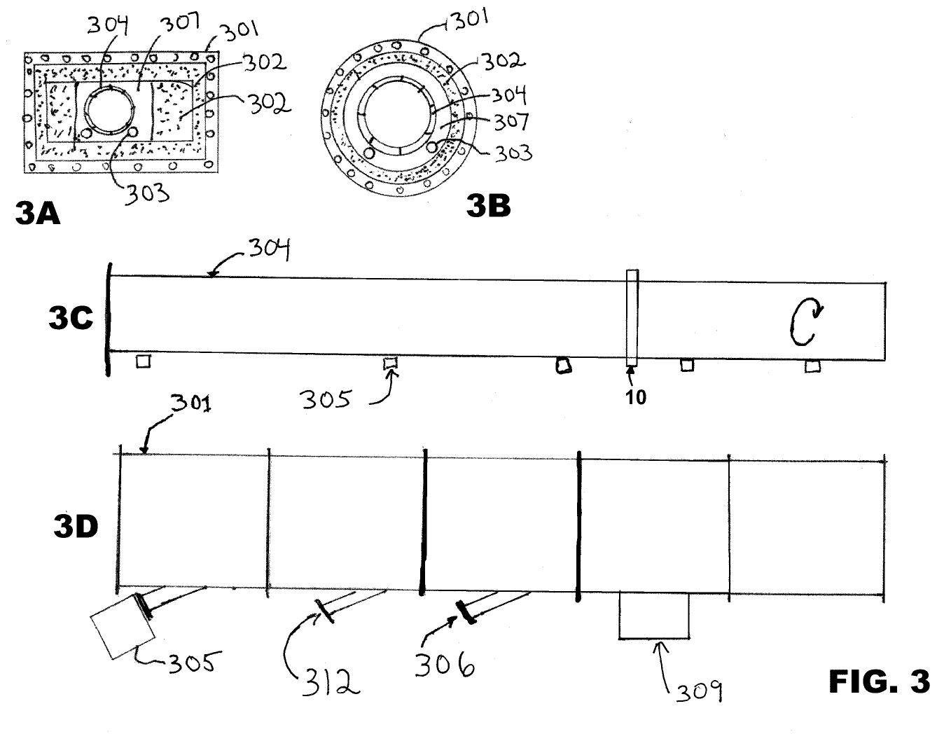

The rotary heating chamber is shown in more detail in FIGS. 3, 4 and 5, with the inner rotating ring 304, the surrounding heated air zone 307, the rollers 303, the insulating refractory material 302, and the stationary outer shell 301 shown in two different configurations with a rectangular outer shell shown in 3A, and a circular outer shell shown in 3B.

Other exemplary embodiments are shown in 3C with the inner rotating ring 304 with an end ring 308, a rotating ring 310, and rollers 303. Another example is shown in 3D with the outer shell 301 and possible inlets 305, 312, and 306 along with a hydraulic rotator 309. Inlet 305 can be an initiator for starting the heating conditions, inlet 312 which receives post-process gases from the gas outlet 7 at the end of the present device, and air impulse injector 306 to add air to the heating process.

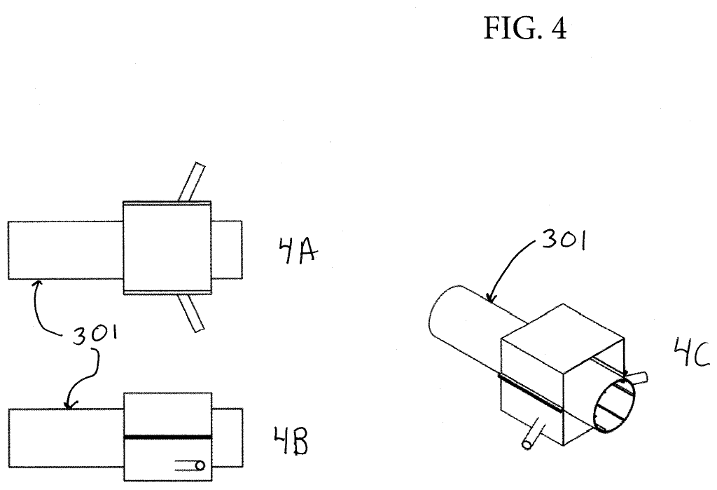

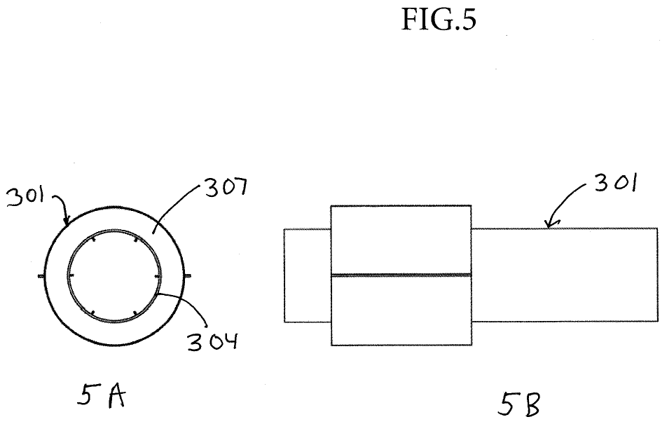

FIG. 4 provides three different views of the processor shown in FIG. 3A with two or more of inlets 305, 306, and 312 shown. FIG. 5 provides two different views of the processor shown in FIG. 3B with no inlets shown on the circular outer shell 301.

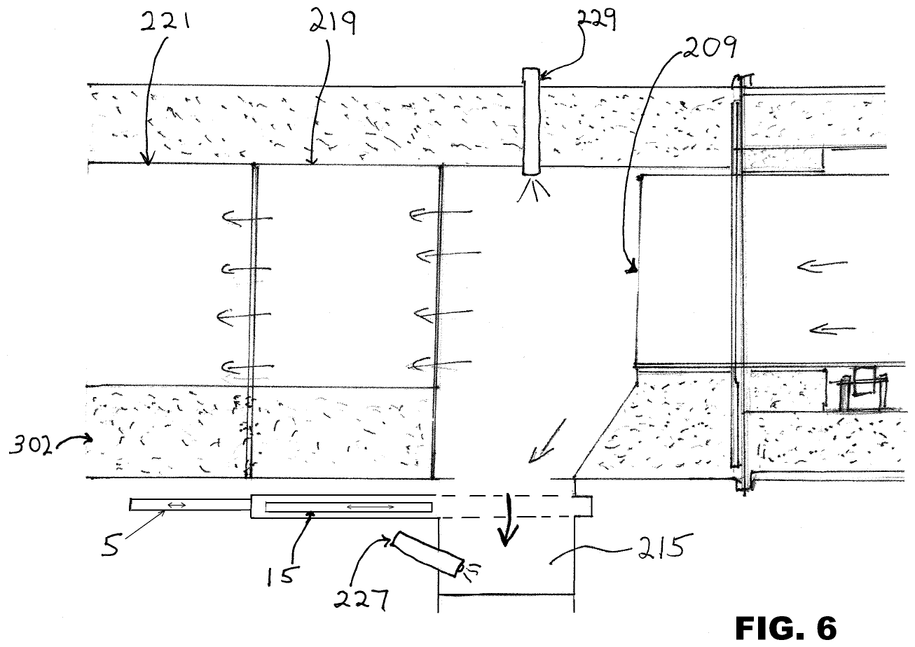

As seen in FIG. 6, unprocessed waste material can be removed from the processor via opening 215, this vertical chamber can be isolated from processor by door 15 operated by ram 5. The post process material can be quenched with water (or another cooling fluid) through sprayers 227. The quenched material can then drop onto another conveyor (not shown) for subsequent processing or disposal.

In some cases, the nozzles 229 can be placed to spray fluids into the hot gas for various reasons including enhancement of favored reactions, such as, Sabatier or water gas shift, to control temperature or to influence process gas formation.

The selection of the processing modules 219, 221, and 223 can vary depending on the desired end product(s) or conditions. For example, in some instances, methane formation may be desired, and in other instances, reduction of nitrogen oxides or sulfur oxide may be desired. Thus, these processing modules can be setup according to waste characteristics, and can be easily changed accordingly. The gas products can then continue onto further processing, such as, a combustion chamber, a heat exchanger, scrubbers, or final filtration, as the case may be.

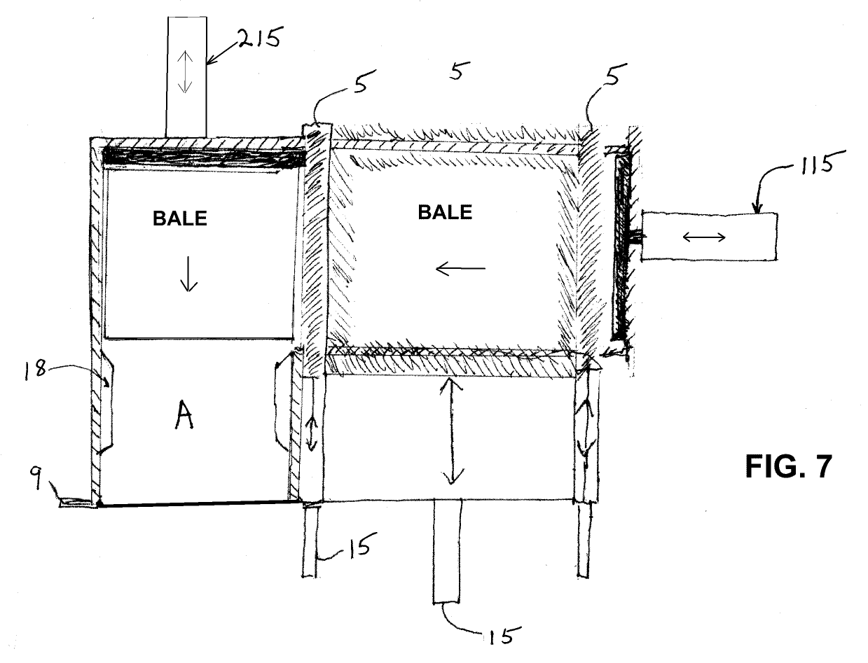

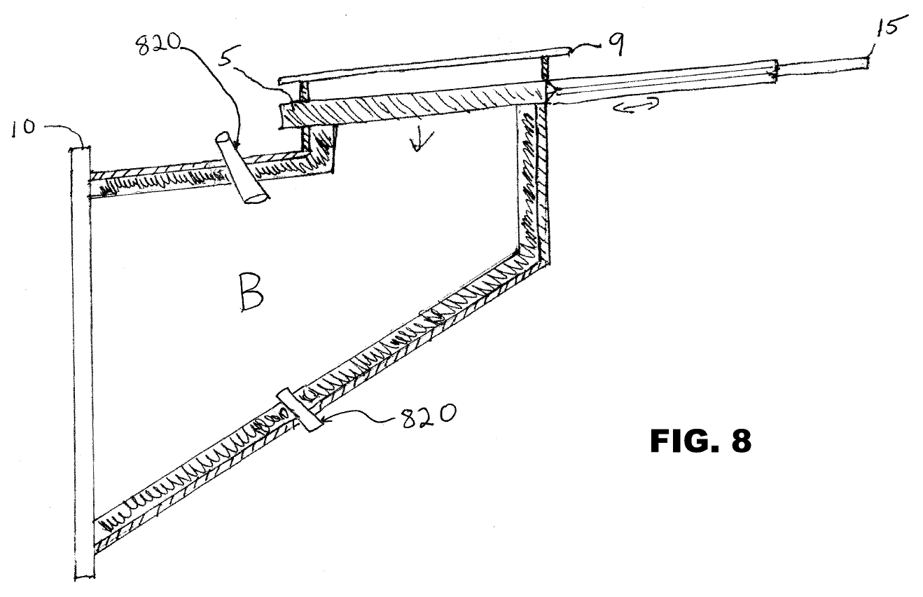

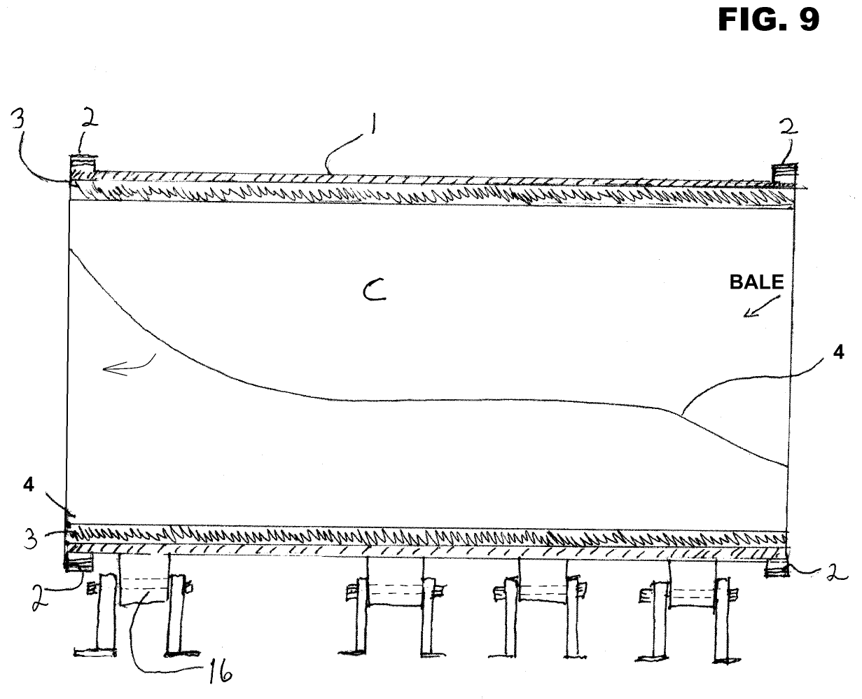

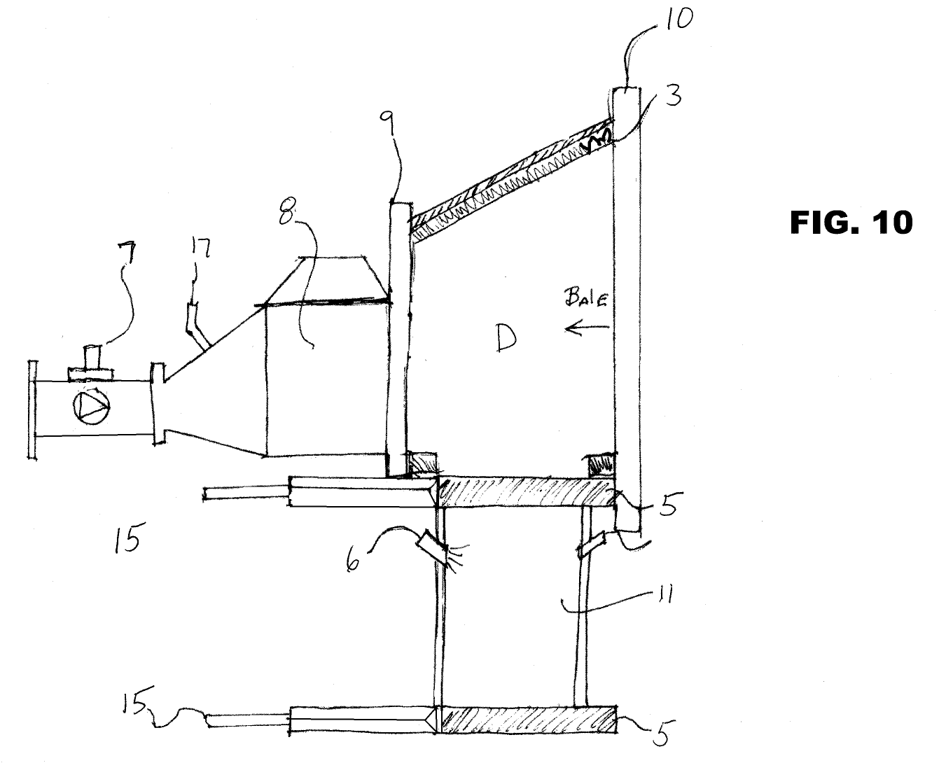

Another embodiment of the present disclosure is represented in FIGS. 7 thru 10, and is described in more detail below. The Figures represent a device for the continuous processing of waste material including a conveyor (not shown) to move bales of waste material into a bale handler. The bale handler receives the bales of waste material from the conveyor, a horizontal ram 115 is used to move the bale left to the entrance to the cutter section A.

The cutter section cuts open bales of waste material, with the blades 18 attached to the interior walls. The blades 18 are adjustable to cut open bales of various sizes.

Pusher devices, for example horizontal ram 115 and vertical ram 215, are located at various locations to push bales vertically and horizontally through the system. Hydraulic pistons 15 are also used to operate doors 5 to open and close the various chambers of the device as the bale and its contents are moved through the device.

A chute B is connected to the outlet 9 of the cutter assembly, and receives the contents of the cut opened bale, or in some cases, loose waste material. The chute B can further include compressed air inlet(s) 820 positioned to move the contents of the cut opened bale through the chute.

A cylindrical rotary calciner C is connected via a rotary union 10 at its first end to the chute B, to receive the contents of the cut opened bale. The cylindrical rotary calciner C can include internal vane 4, fins, etc. positioned to rotate and move the contents of the cut opened bale (or loose waste material) from the first end to the second end of the cylindrical rotary calciner C. Drive gears 2 and rollers 16 can be located on the outer perimeter of the cylindrical rotary calciner. The cylindrical rotary calciner can be heated to a temperature ranging from about 250 to 1000 C. with suitable heat source. In one embodiment of the present disclosure, heated air can be provided to the space between the interior and exterior cylinders making up the cylindrical rotary calciner.

A second rotary union 10 connects the initiator zone D to the second end of the cylindrical rotary calciner. The cylindrical rotary calciner sized to hold the contents of one or more bales. More detail of a cylindrical rotary heating chamber is discussed herein with respect to the embodiment pictured in FIG. 3.

An initiator zone D is connected to the second end of the cylindrical rotary calciner c C and has an opening in its floor leading to a material isolation chute 11. the material isolation chute 11 can further include quench liquid ports 6 positioned on the interior walls to quench the reaction. The initiator zone D is sized to hold the contents of one or more bales for continued processing.

Fluidly connected to the initiator zone D is a carbon chamber 8 which, in turn, is fluidly connected to the gas outlet 7. Filters to remove particles or other substances from the gas product can be located between the carbon chamber 8 and the initiator zone D. The carbon chamber 8 contains one or more components including modules for carbon capture, catalyzed reactions with the gas product, and combinations thereof.

In the presently disclosed processor, the heat source supplies heat to the rotary heating chamber without exposing the waste material to direct fire from the heat source. This characteristic of the presently disclosed processor is critical to the classification of this processor according to U.S. federal regulations.

It is presently understood that the disclosed process can involve gasification, which by itself, is not combustion. According to the present disclosure, while there is combustion of the initial external fuel, for instance natural gas or light fuel oil, in the first few minutes of operation this takes place on the exterior of the rotating cylinder though not exposing the interior to direct fire, this external fuel source can be cut off, which transitions the process to gasification before combustion of the waste feedstock can occur. The gasification process can then be initiated either just outside of, or inside the rotary tumbler which can produce a syngas. The rotary tumbler is understood to modulate or regulate the presence of oxygen in the system and thus prevents combustion of the waste feedstock from occurring. This feature leads the presently disclosed process and device to not meet the criteria established for a commercial and industrial solid waste incineration unit, of “any distinct operating unit of any commercial or industrial facility that combusts, or has combusted in the preceding 6 months, any solid waste as that term is defined 40 CFR Part 241.” Thus, the presently disclosed process and device thus does not fall under US federal regulations 40 CFR Part 241. Accordingly, and for these reason, subpart CCCC of Part 60 does not apply to the process utilized in the presently disclosed device and method.

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A device for the continuous processing of waste material comprising:
a first chamber having an opening sized to accept bales of waste material;
the first chamber connected to a cutter section;
the cutter section having interior walls and an outlet, and comprising cutting blades attached to its interior walls;
a first bale mover to move bales into the first chamber;
a second bale mover to move bales from the first chamber into the cutter section;
a chute connected to the outlet of the cutter section;
a first door located between the cutter section and the chute;
a cylindrical rotary calciner having opposing first and second ends, and connected at its first end to the chute;
the cylindrical rotary calciner comprising at least one internal fin;
a heat source to heat the cylindrical rotary calciner to a processing temperature;
a conversion chamber connected to the second end of the cylindrical rotary calciner;
the conversion chamber having an opening leading to a material removal chute;
a second door located between the conversion chamber and the material removal chute;
a catalyst chamber fluidly connected to the conversion chamber, and
a gas outlet fluidly connected to the catalyst chamber.

2. The device according to claim 1, further comprising a first rotary union connecting the chute to the first end of the cylindrical rotary calciner, and a second rotary union connecting the second end of the cylindrical rotary calciner to the conversion chamber.

3. The device according to claim 1, further comprising drive gears located on the outer perimeter of the cylindrical rotary calciner.

4. The device according to claim 3, wherein the cylindrical rotary calciner is surrounded by a heat containment vessel.

5. The device according to claim 4, wherein the heat source provides heat to a space between the cylindrical rotary calciner and the surrounding heat containment vessel.

6. The device according to claim 1, wherein the heat source supplies heat to the rotary heating chamber without exposing the waste material to direct fire from the heat source.

7. The device according to claim 1, wherein the chute further comprises at least one compressed air inlet positioned to move the contents of the cut opened bale through the chute.

8. The device according to claim 1, wherein the cylindrical rotary calciner and the conversion chamber are each sized to hold the contents of one or more bales.

9. The device according to claim 1, wherein the catalyst chamber contains one or more of a hydrocracking module, a nanoparticle producing module, and a catalyst-based gas conversion module.

10. The device according to claim 1, wherein the material removal chute further comprises one or more quench liquid inlets positioned on the interior walls of the material removal chute.

11. A process for the continuous processing of waste material comprising:
providing bales of waste material;
placing a bale of waste material into a device according to claim 1;
moving the bale of waste material into the first chamber with the first bale mover;
moving the bale of waste material from the first chamber into the cutter section with the second bale mover;
cutting the bale of waste material open with the cutting blades to provide loose waste material and cut baling material;
opening the first door, and moving the loose waste material and cut baling material into the chute, through the chute, and into the cylindrical rotary calciner;
heating the loose waste material and cut baling material to a processing temperature;
processing the loose waste material and cut baling material;
rotating the cylindrical rotary calciner to mix the loose waste material and cut baling material, and move the loose waste material and cut baling material from the first end to the second end of the cylindrical rotary calciner and into the conversion chamber;
continuing the processing of the loose waste material and cut baling material in the conversion chamber, and opening the second door and moving any unprocessed loose waste material and cut bailing material into the material removal chute.

12. The process according to claim 11, wherein any gases produced during the processing of the loose waste material and cut baling material are passed through the catalyst chamber into the gas outlet.

13. The process according to claim 11, further comprising heating the loose waste material and cut baling material to a processing temperature comprises the heat source supplying heat to the rotary heating chamber without exposing the waste material to direct fire from the heat source.

14. The process according to claim 11, wherein the processing temperature ranges from 250 to 1000 C.

15. A continuous feed processor of waste material comprising:
a receiving chamber having first and second openings with the first opening accepting loose waste material;
a conveying system to continuously move the loose waste material;
a rotary heating chamber having starting and finishing openings with the starting opening connected to the second opening of the receiving chamber;
a heat source for heating the rotary heating chamber;
a material removal opening connected to the finishing opening of the rotary heating chamber;
a post-heating chamber connected to the finishing opening of the rotary heating chamber, and the post-heating chamber comprising one or more processing modules.

16. The processor according to claim 15, wherein the waste material comprises loose waste material.

17. The processor according to claim 15, wherein the conveying system comprises a rotary screw, a conveyor belt, or a ram system to move the waste material into the rotary heating chamber.

18. The processor according to claim 15, wherein the heat source supplies heat to the rotary heating chamber without exposing the waste material to direct fire from the heat source.

19. The processor according to claim 15, wherein the rotary heating chamber comprises at least one internal fin.

20. The processor according to claim 15, wherein the one or more processing modules comprise one or more of a hydrocracking module, a nanoparticle producing module, and a catalyst-based gas conversion module.
